(19) United States
(12) Patent Application Publication
(10) Pub. No.: US 2019/0321246 A1
(43) Pub. Date: Oct. 24, 2019

(54) POWER ASSISTED LIFTED SEAT ATTACHMENT

(71) Applicants: Addine Moodie, Plantation, FL (US); Shada Latoya Talbert, Plantation, FL (US)

(72) Inventors: Addine Moodie, Plantation, FL (US); Shada Latoya Talbert, Plantation, FL (US)

(21) Appl. No.: 16/379,208

(22) Filed: Apr. 9, 2019

Related U.S. Application Data
(60) Provisional application No. 62/662,026, filed on Apr. 24, 2018.

(51) Int. Cl. A61G 5/14; A47C 7/02; A47K 13/00; A61G 7/10

(52) U.S. Cl. CPC A61G 5/14; A47C 7/0213; A61G 2203/12; A61G 7/1007; A47K 13/005

(57) ABSTRACT

A power assisted lifted seat attachment is disclosed. Further, the power assisted lifted seat attachment may include a main body including a generally rectangular shaped top panel, a generally rectangular shaped center panel, and a generally rectangular shaped bottom panel. Further, the top panel and the center panel may be pivotally connected along a second top edge and a first center edge. Further, the center panel and the bottom panel may be pivotally connected along a second center edge and a first bottom edge. Further, the power assisted lifted seat attachment may include a movement mechanism connected to the center panel and the bottom panel configured to rotate the center panel with respect to the bottom panel. Further, the power assisted lifted seat attachment may include a controller coupled to the movement mechanism, configured to control the movement mechanism and rotate the center panel with respect to the bottom panel.

### RELATED APPLICATION(S)

Under provisions of 35 U.S.C. § 119e, the Applicant(s) claim the benefit of U.S. provisional application No. 62/662,026, filed on 24 Apr. 2018, which is incorporated herein by reference.

### FIELD OF THE INVENTION

The disclosure relates generally to health care equipment and accessories, and in particular to a power assisted lifting seat attachment.

### BACKGROUND OF THE INVENTION

The proliferation of elderly and disabled persons, and the diminishing number of younger people available to provide care, has been challenging for many modern societies. Due to the additional challenges of living in smaller residential spaces, such as apartments and condominiums, space saving portable devices which may be used to assist in the home care of elderly and disabled persons have proven to be useful. In particular, devices which may be used to assist elderly and disabled persons in becoming more mobile and self-sufficient are very useful for such persons and their caregivers. If a portable device could be developed which gently but powerfully assists a person to slowly stand from a sitting position, then return to a sitting position at a later time, such a device would be useful, and would be well received.

Therefore, there is a need for an improved power assisted lifted seat attachment that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a power assisted lifted seat attachment is disclosed. Further, the power assisted lifted seat attachment may include a main body including a generally rectangular shaped top panel, a generally rectangular shaped center panel, and a generally rectangular shaped bottom panel. Further, the top panel may extend from a first top edge to an oppositely located second top edge. Further, the center panel may extend from a first center edge to an oppositely located second center edge. Further, the bottom panel may extend from a first bottom edge to an oppositely located second bottom edge. Further, the top panel and the center panel may be pivotally connected along the second top edge and the first center edge. Further, the center panel and the bottom panel may be pivotally connected along the second center edge and the first bottom edge.

Further, the power assisted lifted seat attachment may include a movement mechanism connected to the center panel and the bottom panel. Further, movement mechanism may be configured to rotate the center panel with respect to the bottom panel.

Further, the power assisted lifted seat attachment may include a controller coupled to the movement mechanism. Further, the controller may be configured to control the movement mechanism and rotate the center panel with respect to the bottom panel.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a power assisted lifted seat attachment, in accordance with some embodiments.

FIG. 2 is a top view of the power assisted lifted seat attachment, in accordance with some embodiments.

FIG. 3 is a front view of the power assisted lifted seat attachment, in accordance with some embodiments.

FIG. 4 is a left side view of the power assisted lifted seat attachment in a retracted position, in accordance with some embodiments.

FIG. 5 is a right side view of the power assisted lifted seat attachment in a folded position, in accordance with some embodiments.

FIG. 6 is a perspective view of the power assisted lifted seat attachment including a wire, in accordance with some embodiments.

FIG. 7 is a perspective view of the power assisted lifted seat attachment, in accordance with some embodiments.

FIG. 8 is a side view of the power assisted lifted seat attachment in a partially extended position, in accordance with some embodiments.

FIG. 9 is a side view of the power assisted lifted seat attachment in an extended position, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of power assisted lifted seat attachment, embodiments of the present disclosure are not limited to use only in this context.

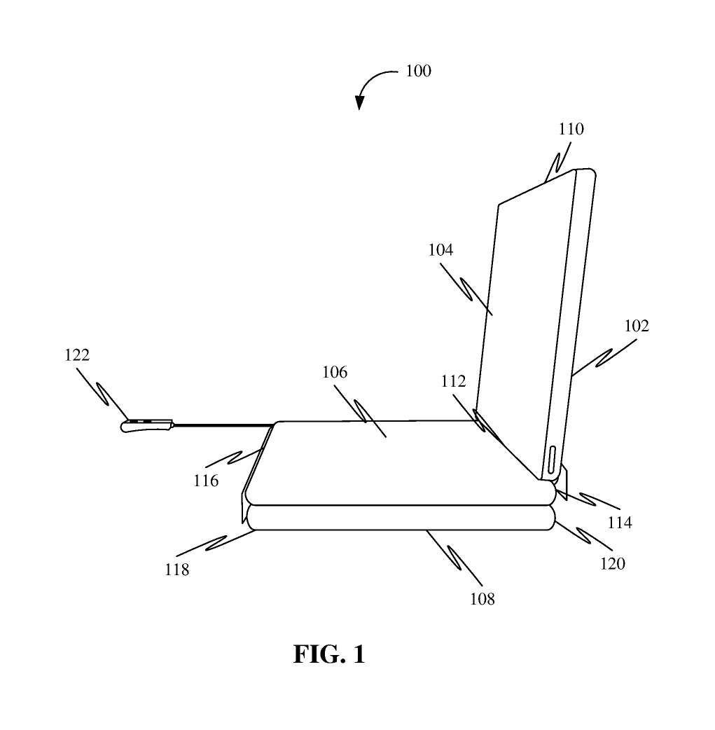

FIG. 1 is a power assisted lifted seat attachment 100, in accordance with some embodiments. Further, the power assisted lifted seat attachment 100 may include a main body 102 including a generally rectangular shaped top panel 104, a generally rectangular shaped center panel 106, and a generally rectangular shaped bottom panel 108. Further, the top panel 104 may extend from a first top edge 110 to an oppositely located second top edge 112. Further, the center panel 106 may extend from a first center edge 114 to an oppositely located second center edge 116. Further, the bottom panel 108 may extend from a first bottom edge 118 to an oppositely located second bottom edge 120. Further, the top panel 104 and the center panel 106 may be pivotally connected along the second top edge 112 and the first center edge 114. Further, the center panel 106 and the bottom panel 108 may be pivotally connected along the second center edge 116 and the first bottom edge 118.

Further, the power assisted lifted seat attachment 100 may include a movement mechanism connected to the center panel 106 and the bottom panel 108. Further, movement mechanism may be configured to rotate the center panel 106 with respect to the bottom panel 108.

Further, the power assisted lifted seat attachment 100 may include a controller 122 coupled to the movement mechanism. Further, the controller 122 may be configured to control the movement mechanism and rotate the center panel 106 with respect to the bottom panel 108.

Further, in some embodiments, the movement mechanism may include at least one rotary member. Further, the rotary member may be configured to act as a component along which the center panel 106 is configured to rotate. Further, the rotary member may include at least one of a shaft, a spindle, a hinge,

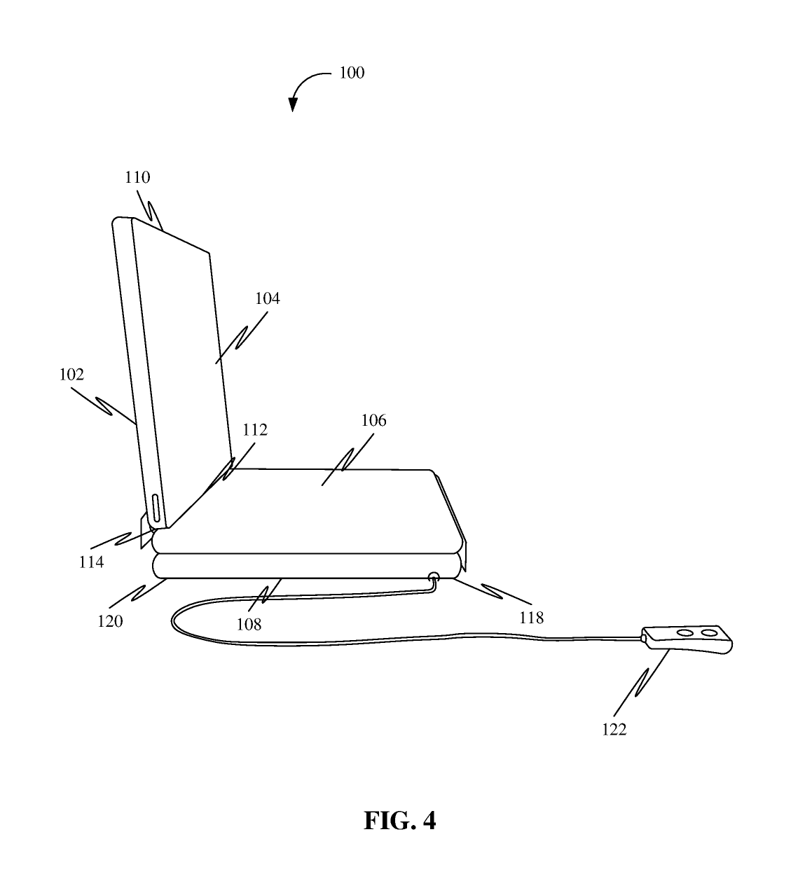

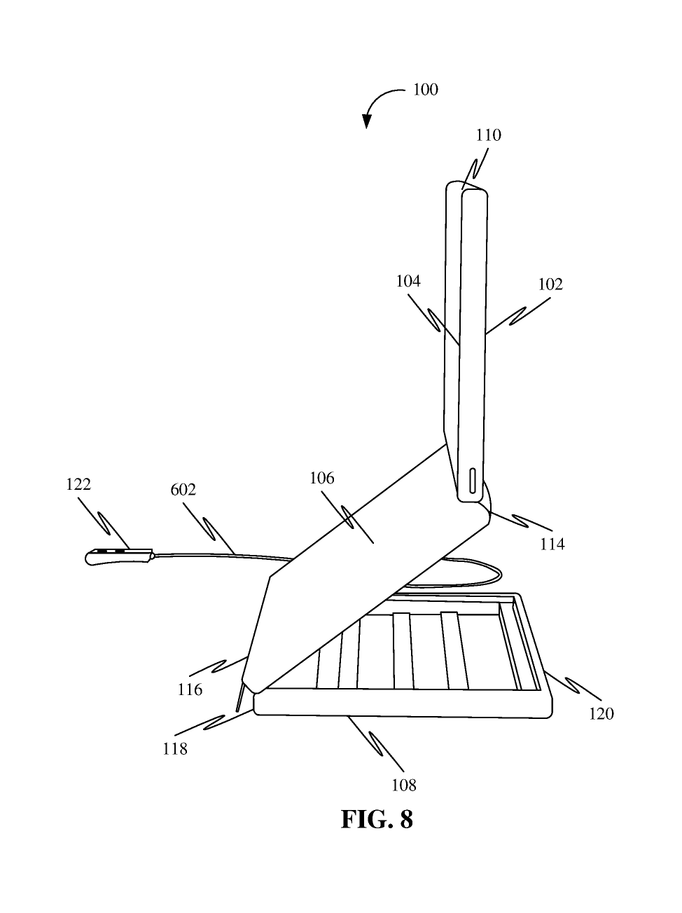

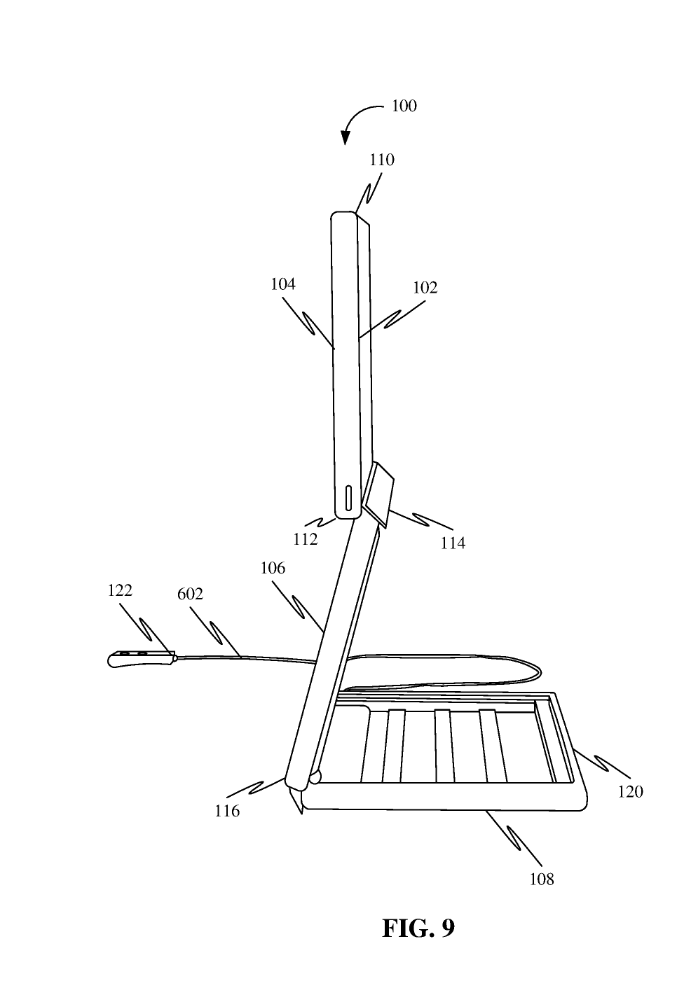

Further, in some embodiments, corresponding to the main body being in a retracted position, as shown in FIG. 4, the center panel 106 may be folded horizontally over the bottom panel 108 such that the second center edge 116 and the first bottom edge 118 may overlap, and the top panel 104 may be in a significantly perpendicular position to the center panel 106. Further, in some embodiments, in the significantly perpendicular position the top panel 104 may be cantered slightly away from the center panel 106. Further, in some embodiments, in the significantly perpendicular position, the top panel 104 may make an angle between 70 degrees and 110 degrees with the center panel 106. Further, corresponding to the main body being in an extended position, as shown in FIG. 9, the bottom panel 108 may be horizontal, and the center panel 106 may be in a significantly perpendicular position to the bottom panel 108. Further, in some embodiments, in the significantly perpendicular position, the center panel 106 may be cantered slightly away from the bottom panel 108. Further, in some embodiments, in the significantly perpendicular position, the center may make an angle between 70 degrees and 110 degrees with the bottom panel 108. Further, in some embodiments, as shown in FIG. 8, the main body may be in a partially extended position while moving from the retracted position to the extended position.

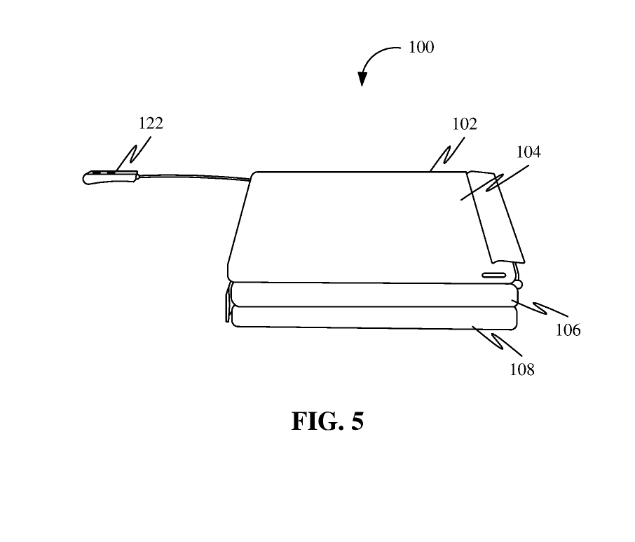

Further, in some embodiments, corresponding to the main body being in a folded position, as shown in FIG. 5 the center panel 106 may be folded horizontally over the bottom panel 108 such that the second center edge 116 and the first bottom edge 118 may overlap, and the top panel 104 may be folded horizontally over the center panel 106 such that the second top edge 112 and the first center edge 114 may overlap. Further, in the folded position, the power assisted lifted seat attachment 100 may be easily stores and/or carried.

Further, in some embodiments, the movement mechanism may be configured to move the main body between the retracted position and the extended position.

Further, in some embodiments, the center panel 106 may be configured to rotate between an angle of 0 degrees and 90 degrees with respect to the bottom panel 108. Further, the center panel 106 may make an angle of 0 degrees with the bottom panel 108 in the folded state, and the retracted state. Further, the center panel 106 may make an angle of 90 degrees with the bottom panel 108 in the extended state.

Further, in some embodiments, the movement mechanism may include an electric motor configured to rotate the at least one rotary member through electrical means. Further, in some embodiments, the electric motor may include a servo motor.

Further, in some embodiments, the electric motor may be powered by a power source. Further, the power source may include at least one of a portable power source including a battery, or a connection to electric mains.

Further, in some embodiments, the electrical movement mechanism may be controllable by the controller 122. Further, the controller 122 may be configured to control the electrical movement mechanism and rotate the center panel 106 with respect to the bottom panel 108. Further, the controller 122 may be configured to control the electrical movement mechanism by controlling the power to the electrical movement mechanism provided through the power source.

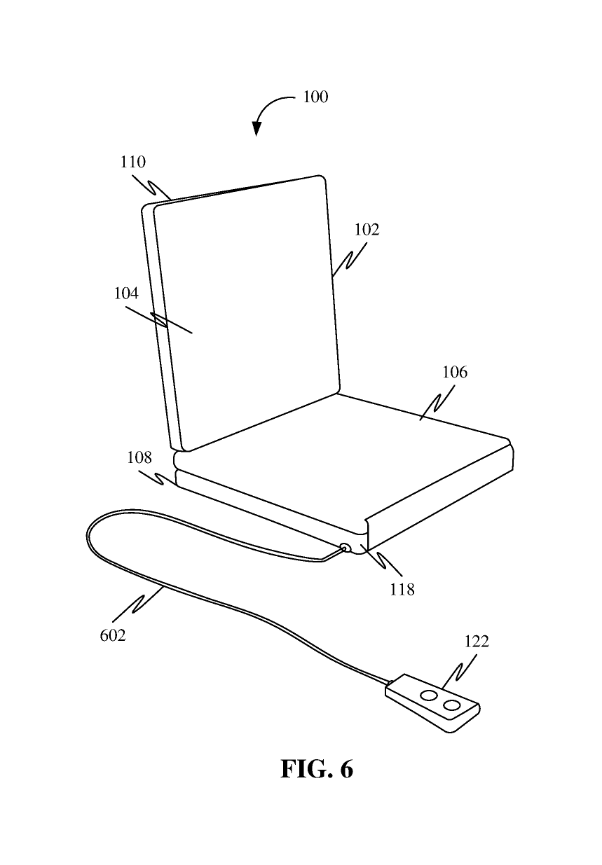

Further, in some embodiments, the controller 122 may include at least one of a wired controller and a wireless controller. Further, the wired controller may be coupled to the electrical movement mechanism through a wire 602 as shown in FIG. 6. Further, the wireless electrical controller may be communicatively coupled to the electric motor over a communication network including at least one of Wi-Fi, Bluetooth, NFC, ZigBee, and a mobile communication network.

Further, in some embodiments, the movement mechanism may include a mechanical movement mechanism configured to rotate the at least one rotary member through mechanical means. Further, the mechanical movement mechanism may include a pneumatic mechanism including a pressurized gas column driving an extendable shaft connected to a piston. Further, the extendable shaft may extend and causes the center panel 106 to rotate about the rotary member of the mechanical movement mechanism.

Further, in some embodiments, the movement mechanism may be controllable by the controller 122 including a mechanical controller. Further, the mechanical controller may be configured to control the mechanical movement mechanism and rotate the center panel 106 with respect to the bottom panel 108. Further, the mechanical controller may include a lever connected to the piston configured to lock the piston of the mechanical movement mechanism while gas column of the mechanical movement mechanism may be in a pressurized state. Further, the mechanical controller may engage the mechanical movement mechanism by unlocking the piston allowing the gas column of the mechanical movement mechanism to expand and move the extendable shaft.

Further, in some embodiments, a second movement mechanism may be connected to the center panel 106 and the top panel 104, including at least one second rotary member. Further, the second movement mechanism may be configured to rotate the top panel 104 with respect to the center panel 106 between an angle of 0 degrees and 90 degrees. Further, the second movement mechanism may be configured to maintain the top panel 104 in a significantly vertical orientation while in the extended position.

Further, in some embodiments, the second movement mechanism may be coupled to the controller 122. Further, the controller 122 may be configured to control the second movement mechanism and rotate the top panel 104 with respect to the center panel 106 between an angle of 0 degrees and 90 degrees.

Further, in some embodiments, the power assisted lifted seat attachment 100 may include a gripping member connected to the bottom panel 108. Further, the gripping member may be configured to removably attach the power assisted lifted seat attachment 100 to an external seat.

Further, in some embodiments, the gripping member connected to the bottom panel 108 may include at least one of at least one clamp, at least one vice, a screw, and at least one flexible clip.

Further, in some embodiments, the gripping member may be configured to be attached to an external seat, including a chair, a cushion, a bench, a car seat, and a stool.

Further, in some embodiments, the gripping member may be configured to be attached to an external seat including a toilet seat. Further, the center panel 106, and the bottom panel 108 include openings corresponding to a bowl associated with the toilet seat, Further, in some embodiments, the openings in the center panel 106 and the bottom panel 108 correspond to 16½ inches for round toilet seats, and 18½ inches for elongated toilet seats,

Further, in some embodiments, the top panel 104, the center panel 106, and the bottom panel 108 are manufactured from a rigid, durable material with substantial structural strength, including at least one of steel and aluminum alloy. Further, the top panel 104 and the center panel 106 comprise additional padding manufactured from a flexible, durable material including at least one of foam and rubber. Further, the top panel 104 and the center panel 106 comprise additional upholstery including a flexible and durable material including at least one of leather, and cotton fabric.

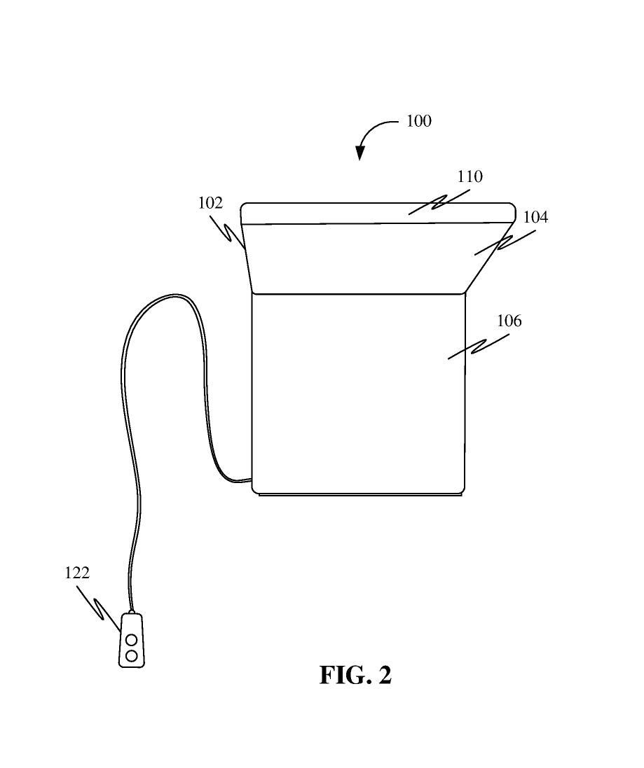

FIG. 2 is a top view of the power assisted lifted seat attachment 100, in accordance with some embodiments.

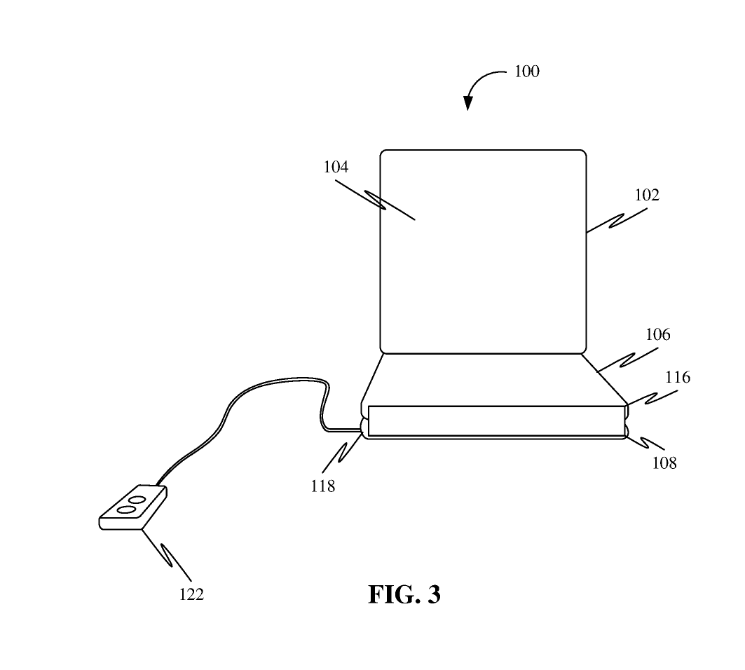

FIG. 3 is a front view of the power assisted lifted seat attachment 100, in accordance with some embodiments.

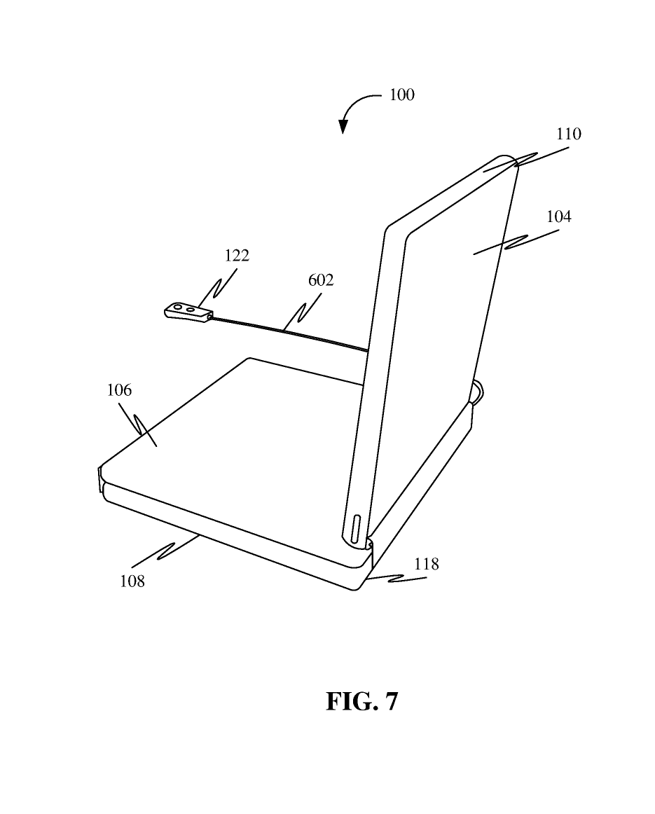

FIG. 7 is a perspective view of the power assisted lifted seat attachment 100, in accordance with some embodiments.

According to an exemplary embodiment, a power assisted lifting seat attachment is disclosed,

The power assisted lifting seat attachment may include a seat, such as the main body 102 including three square or rectangular panels in a Z-shaped configuration, consisting of a top panel, such as the top panel 104, a center panel, such as the center panel 106, and a bottom panel, such as the bottom panel 108. In a standard position, such as the retracted position, the center panel may be folded horizontally over the bottom panel, and the top panel may be canted slightly back from a vertical position. In the standard position, the top surface of the center panel and the front surface of the top panel may be padded, such that an adult user may sit comfortably on the center panel with the user's back resting against the top panel. Clamps, flexible clips, or similar devices may be included in the power assisted lifted seat attachment 100 to secure the bottom panel to a chair or bench.

Reduction geared servomotors may be provided within the power assisted lifting seat attachment, which may slowly raise the center panel and the top panel to a vertical position when activated to assists a user sitting on the power assisted lifting seat attachment to rise from a seated posture to a standing posture. When both the top panel and the center panel are vertical, the power assisted lifting seat attachment may be in a fully extended position. Further, in an embodiment, the servomotors may be reversible, enabling the user to use power assisted lifting seat attachment to slowly return to a seated posture.

Further, in an embodiment, the servomotors may be powered by electric mains, and a power cord may be included in the power assisted lifting seat attachment which may be plugged into any wall outlet or extension cord. The servomotors may be controlled by a remote control which may be connected to the servomotors by a remote control cord, such as the wire 602. When not in use, the top panel may be folded down onto the center panel for compact storage and transport, such as corresponding to the folded position.

To use the power assisted lifting seat attachment, the user may secure the bottom panel to a chair or bench, using the clamps, flexible clips, or similar devices. The user may then plug the power cord into a wall outlet, and sit on the center panel. When the user desires to rise to a standing posture, the user may activate the servomotors using the remote control. The servomotors may slowly raise the top panel and center panel such that the top panel and the center panel are vertical, gently lifting the user into a standing posture.

The top panel, the center panel, and the lower panel may be manufactured from a rigid, durable material with substantial structural strength, such as steel or aluminum alloy, with padding on the top panel. Further, the center panel may be preferably manufactured from a flexible, durable material such as foam rubber, upholstered with a flexible, durable material such as leather or cotton fabric. The remote control and the servomotors may be manufactured from rigid, durable materials such as steel, aluminum alloy, copper alloy, brass, ceramics, and plastic. Further, in an embodiment, the remote control cord and the power cord may be preferably manufactured from braided copper alloy wire sheathed in plastic.

Components, component sizes, and materials listed above are preferable, but artisans will recognize that alternate components and materials could be selected without altering the scope of the disclosure.

While the foregoing written description of the disclosure enables one of ordinary skill to make and use what may be presently considered to be the best mode thereof, those of ordinary skill in the art will understand and appreciate the existence of variations, combinations, and equivalents of the specific embodiment, method, and examples herein. The disclosure should, therefore, not be limited by the above described embodiment, method, and examples, but by all embodiments and methods within the scope and spirit of the disclosure.

Although the disclosure has been explained in relation to its preferred embodiment, it is to be understood that many other possible modifications and variations can be made without departing from the spirit and scope of the disclosure.

What is claimed is:

1. A power assisted lifted seat attachment comprising:
a main body comprising a generally rectangular shaped top panel, a generally rectangular shaped center panel, and a generally rectangular shaped bottom panel, wherein the top panel extends from a first top edge to an oppositely located second top edge, wherein the center panel extends from a first center edge to an oppositely located second center edge, wherein the bottom panel extends from a first bottom edge to an oppositely located second bottom edge, wherein the top panel and the center panel are pivotally connected along the second top edge and the first center edge, wherein the center panel and the bottom panel are pivotally connected along the second center edge and the first bottom edge;
a movement mechanism connected to the center panel and the bottom panel, wherein movement mechanism is configured to rotate the center panel with respect to the bottom panel; and
a controller coupled to the movement mechanism, wherein the controller is configured to control the movement mechanism and rotate the center panel with respect to the bottom panel.

2. The power assisted lifted seat attachment of claim 1, wherein the movement mechanism comprises at least one rotary member, wherein the rotary member is configured to act as a component along which the center panel is configured to rotate, wherein the rotary member includes at least one of a shaft, a spindle, a hinge,

3. The power assisted lifted seat attachment of claim 1 wherein, corresponding to the main body being in a retracted position, the center panel is folded horizontally over the bottom panel such that the second center edge and the first bottom edge overlap, and the top panel is in a significantly perpendicular position to the center panel, wherein corresponding to the main body being in an extended position, the bottom panel is horizontal, and the center panel is in a significantly perpendicular position to the bottom panel.

4. The power assisted lifted seat attachment of claim 1, wherein corresponding to the main body being in a folded position, the center panel is folded horizontally over the bottom panel such that the second center edge and the first bottom edge overlap, and the top panel is folded horizontally over the center panel such that the second top edge and the first center edge overlap.

5. The power assisted lifted seat attachment of claim 2, wherein the movement mechanism is configured to move the main body between the retracted position and the extended position.

6. The power assisted lifted seat attachment of claim 1, wherein the center panel is configured to rotate between an angle of 0 degrees and 90 degrees with respect to the bottom panel.

7. The power assisted lifted seat attachment of claim 2, wherein the movement mechanism includes an electric motor configured to rotate the at least one rotary member through electrical means.

8. The power assisted lifted seat attachment of claim 7, wherein the electric motor is powered by a power source, wherein the power source includes at least one of a portable power source including a battery, or a connection to electric mains.

9. The power assisted lifted seat attachment of claim 7, wherein the electrical movement mechanism is controllable by the controller, wherein the controller is configured to control the electrical movement mechanism and rotate the center panel with respect to the bottom panel, wherein the controller is configured to control the electrical movement mechanism by controlling the power to the electrical movement mechanism provided through the power source.

10. The power assisted lifted seat attachment of claim 9, wherein the controller comprises at least one of a wired controller and a wireless controller, wherein the wired controller is coupled to the electrical movement mechanism through a wire, wherein the wireless electrical controller is communicatively coupled to the electric motor over a communication network including at least one of Wi-Fi, Bluetooth, NFC, ZigBee, and a mobile communication network.

11. The power assisted lifted seat attachment of claim 2, wherein the movement mechanism includes a mechanical movement mechanism configured to rotate the at least one rotary member through mechanical means, wherein the mechanical movement mechanism includes a pneumatic mechanism including a pressurized gas column driving an extendable shaft connected to a piston, wherein the extendable shaft extends and causes the center panel to rotate about the rotary member of the mechanical movement mechanism.

12. The power assisted lifted seat attachment of claim 11, wherein the movement mechanism is controllable by the controller comprising a mechanical controller, wherein the mechanical controller is configured to control the mechanical movement mechanism and rotate the center panel with respect to the bottom panel, wherein the mechanical controller comprises a lever connected to the piston configured to lock the piston of the mechanical movement mechanism while gas column of the mechanical movement mechanism is in a pressurized state, wherein the mechanical controller engages the mechanical movement mechanism by unlocking the piston allowing the gas column of the mechanical movement mechanism to expand and move the extendable shaft.

13. The power assisted lifted seat attachment of claim 1, wherein a second movement mechanism is connected to the center panel and the top panel, comprising at least one second rotary member, wherein the second movement mechanism is configured to rotate the top panel with respect to the center panel between an angle of 0 degrees and 90 degrees, wherein the second movement mechanism is configured to maintain the top panel in a significantly vertical orientation while in the extended position.

14. The power assisted lifted seat attachment of claim 11, wherein the second movement mechanism is coupled to the controller, wherein the controller is configured to control the second movement mechanism and rotate the top panel with respect to the center panel between an angle of 0 degrees and 90 degrees.

15. The power assisted lifted seat attachment of claim 1 comprising a gripping member connected to the bottom panel, wherein the gripping member is configured to removably attach the power assisted lifted seat attachment to an external seat.

16. The power assisted lifted seat attachment of claim 12, wherein the gripping member connected to the bottom panel includes at least one of at least one clamp, at least one vice, a screw, and at least one flexible clip.

17. The power assisted lifted seat attachment of claim 12, wherein the gripping member is configured to be attached to an external seat, including a chair, a cushion, a bench, a car seat, and a stool.

18. The power assisted lifted seat attachment of claim 1, wherein the gripping member is configured to be attached to an external seat including a toilet seat wherein the center panel, and the bottom panel include openings corresponding to a bowl associated with the toilet seat.

19. The power assisted lifted seat attachment of claim 16, wherein the openings in the center panel and the bottom panel correspond to 16½ inches for round toilet seats, and 18½ inches for elongated toilet seats,

20. The power assisted lifted seat attachment of claim 1, wherein the top panel, the center panel, and the bottom panel are manufactured from a rigid, durable material with substantial structural strength, including at least one of steel and aluminum alloy, wherein the top panel and the center panel comprise additional padding manufactured from a flexible, durable material including at least one of foam and rubber, wherein the top panel and the center panel comprise additional upholstery comprising a flexible and durable material including at least one of leather, and cotton fabric.
